(19) United States
(12) Patent Application Publication
(10) Pub. No.: US 2025/0373093 A1
(43) Pub. Date: Dec. 4, 2025

(54) MOTOR WITH IN-SLOT STATOR COOLING

(71) Applicant: FORD GLOBAL TECHNOLOGIES, LLC, Dearborn, MI (US)

(72) Inventors: Akash Changarankumarath Pradeepkumar, Westland, MI (US); Singar Rathnam, Farmington Hills, MI (US)

(21) Appl. No.: 18/733,361

(22) Filed: Jun. 4, 2024

(51) Int. Cl. H02K 1/20; H02K 1/16; H02K 3/24

(52) U.S. Cl. CPC H02K 1/20; H02K 1/16; H02K 3/24

(57) ABSTRACT

A stator for an electrified vehicle motor includes axial coolant channels around the windings. Radial coolant channels join these axial channels to an exterior surface of the stator core. Coolant is pumped through the radial channels to a central location along the axial channels. From there, the coolant flows axially absorbing heat from the straight sections of the windings and then flow out both ends of the stator core cooling the end windings.

### TECHNICAL FIELD

The present disclosure relates to a motor for an electrified vehicle. More particularly, it relates to a motor in which coolant flows through slots of the stator to cool the windings.

### BACKGROUND

Electrified vehicles utilize one of more electric motors for propulsion, either in combination with an internal combustion engine or instead of an internal combustion engine. During operation, it may be necessary to limit the motor’s power output. Active cooling systems may increase the ability to remove heat from the motor, thereby reducing the need to limit motor output.

### SUMMARY

A stator for an electric motor includes a magnetically conductive core, electrically conductive windings, and a barrier. The magnetically conductive core has two end surfaces connected by an outer surface and an inner surface. The inner surface defines a plurality of axial stator poles separated by a plurality of axial slots. The core further defines a plurality of radial coolant channels between the outer surface and the slots. The electrically conductive windings are located at least partially within the slots. The barrier connects tips of the stator poles to close off the slots thereby defining axial coolant channels around the windings and extending between the end surfaces. The core may include a stack of laminations. Each lamination may form a segment of the outer surface, the stator poles, and the axial slots. The stack may include a first and a second lamination at a central location. The first lamination may define a plurality of first radial grooves each extending from the outer surface towards one of the axial slots. The second lamination may define a plurality of second radial grooves each extending from one of the slots toward the outer surface and abutting one of the first radial grooves to form one of the radial coolant channels. The first radial grooves may not extend to the axial slot and the second radial grooves may not extend to the outer surface. The stator may also include two end caps connected to opposite ends of the barrier. The end caps may define slots to position the windings. The barrier and the end caps may be electrical and magnetic insulators such as plastic. A subset of the axial coolant channels may be filled with varnish.

A stator core includes a stack of laminations. Each lamination has a cylindrical outer surface and flat end surfaces. Each lamination has a plurality of inward facing projections. A first lamination defines a plurality of first radial grooves in one of the flat end surfaces. Each first radial groove extends inwardly from the outer surface. A second lamination defines a plurality of second radial grooves in one of the flat end surfaces. Each second radial groove extends outwardly from between two of the projections and abuts one of the first radial grooves to form a radial channel. The first radial grooves may not extend to an inner surface and the second radial grooves may not extend to the outer surface. A barrier may connect tips of the projections to define axial coolant channels. Two end caps may be connected to opposite ends of the barrier and may have slots to position windings.

A motor includes a magnetically conductive stator core, electrically conductive windings, a barrier, and a pump. The magnetically conductive stator core has two end surfaces connected by an outer surface and an inner surface. The inner surface defines a plurality of axial stator poles separated by a plurality of axial slots. The stator core further defines a plurality of radial coolant channels between the outer surface and the slots. The electrically conductive windings are located at least partially within the slots. The barrier connects tips of the stator poles to close off the slots thereby defining the axial coolant channels around the windings. The pump is configured to propel a coolant through the radial cooling channels into the axial coolant channels. The motor may also include a rotor supported for rotation within the stator core. The core may include a stack of laminations. Each lamination may form a segment of the outer surface, the stator poles, and the axial slots. A first lamination may define a plurality of first radial grooves extending from the outer surface towards one of the axial slots. A second lamination may define a plurality of second radial grooves each extending from one of the slots toward the outer surface and abutting one of the first radial grooves to form one of the radial coolant channels. The first radial grooves may not extend to the axial slot and the second radial grooves may not extend to the outer surface. Two end caps may be connected to opposite ends of the barrier. The end caps may define slots to position the windings. The barrier and the end caps may be electrical and magnetic insulators, such as plastic. A subset of the axial coolant channels may be filled with varnish.

### BRIEF DESCRIPTION OF THE DRAWINGS

FIG. 1 illustrates a block diagram of an electrified vehicle.

FIG. 2 is a cross-sectional view of an electric motor suitable for use in the electrified vehicle of FIG. 1.

FIG. 3 is a cross-sectional view of the stator of the motor of FIG. 2.

FIG. 4 is an end view of the stator of FIG. 3.

FIG. 5 is an end view of one of the laminations of the stator of FIG. 3.

FIG. 6 is an end view of another of the laminations of the stator of FIG. 3.

FIG. 7 is an end view of an alternative lamination to the laminations of FIGS. 5 and 6.

FIG. 8 is a flowchart for a process of fabricating the stator of FIG. 3.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

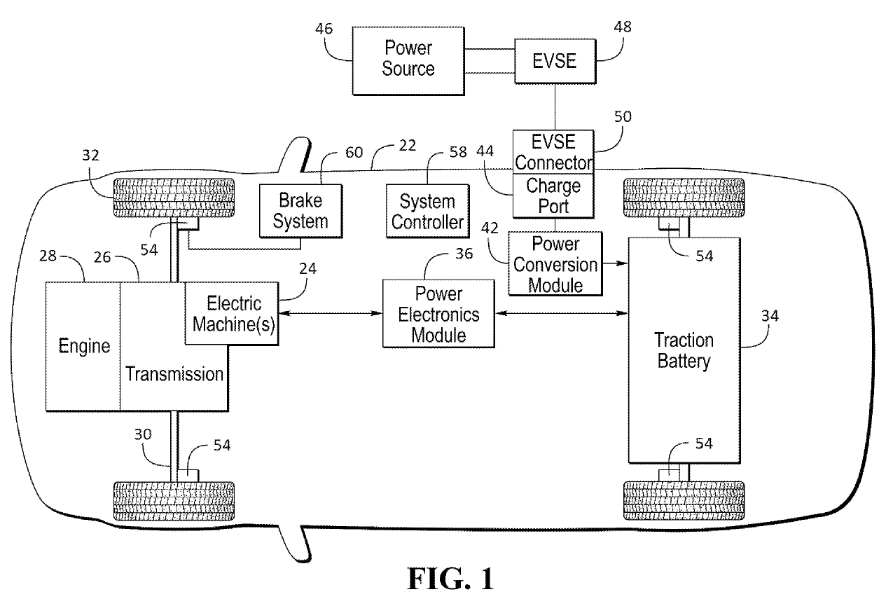

Referring now to FIG. 1, a block diagram of an exemplary electric vehicle (“EV”) 22 is shown. In this example, EV 22 is a plug-in hybrid electric vehicle (PHEV). EV 22 includes one or more electric machines 24 (“e-machines” or motors) mechanically connected to a transmission 26. Electric machine 24 is capable of operating as a motor and as a generator. Transmission 26 is mechanically connected to an engine 28 and to a drive shaft 30 mechanically connected to wheels 32. Electric machine 24 can provide propulsion and slowing capability while engine 28 is turned on or off. Electric machine 24 acting as a generator can recover energy that may normally be lost as heat. Electric machine 24 may reduce vehicle emissions by allowing engine 28 to operate at more efficient speeds and allowing EV 22 to be operated in electric mode with engine 28 off under certain conditions.

A traction battery 34 (“battery) stores energy that can be used by electric machine 24 for propelling EV 22. Battery 34 typically provides a high-voltage (HV) direct current (DC) output. Battery 34 is electrically connected to a power electronics module 36. Power electronics module 36 is electrically connected to electric machine 24 and provides the ability to bi-directionally transfer energy between battery 34 and the electric machine. For example, battery 34 may provide a DC voltage while electric machine 24 may require a three-phase alternating current (AC) voltage to function. Power electronics module 36 may convert the DC voltage to a three-phase AC voltage to operate electric machine 24. In a regenerative mode, power electronics module 36 may convert three-phase AC voltage from electric machine 24 acting as a generator to DC voltage compatible with battery 34.

Battery 34 is rechargeable by an external power source 46 (e.g., the grid). Electric vehicle supply equipment (EVSE) 48 is connected to external power source 46. EVSE 48 provides circuitry and controls to control and manage the transfer of energy between external power source 46 and EV 22. External power source 46 may provide DC or AC electric power to EVSE 48. EVSE 48 may have a charge connector 50 for plugging into a charge port 44 of EV 22. Charge port 44 may be any type of port configured to transfer power from EVSE 48 to EV 22. A power conversion module 42 of EV 22 may condition power supplied from EVSE 48 to provide the proper voltage and current levels to battery 34. Power conversion module 42 may interface with EVSE 48 to coordinate the delivery of power to battery 34. Alternatively, various components described as being electrically connected may transfer power using a wireless inductive coupling.

The various components discussed may have one or more associated controllers to control and monitor the operation of the components. The controllers can be microprocessor-based devices. The controllers may communicate via a serial bus (e.g., Controller Area Network (CAN)) or via discrete conductors. For example, a system controller 58 (i.e., a vehicle controller) is present to coordinate the operation of the various components.

As described, EV 22 is in this example is a PHEV having engine 28 and battery 34. In other embodiments, EV 22 is a battery electric vehicle (BEV). In a BEV configuration, EV 22 does not include an engine.

In the context of electric and hybrid electric vehicles, motors convert electrical energy into mechanical energy, driving the wheels and enabling motion. The efficiency of electric motors in vehicles is significantly higher than traditional internal combustion engines, often achieving efficiencies between 85% and 95%. This high efficiency, coupled with their ability to deliver maximum torque from a standstill, makes electric motors suitable for automotive applications.

AC motors, particularly induction motors and permanent magnet synchronous motors (PMSM), are prevalent in modern electric vehicles. PMSMs are known for their efficiency and high power density, providing precise speed control across a broad range of operating conditions.

Cooling of electric motors may be necessary to maintain optimal performance and prolong the life of the motor, especially when operating under high load or adverse conditions. The simplest cooling method is air cooling, which uses ambient airflow or forced air through fans to remove heat from the motor. Air cooling is typically more suitable for smaller or less demanding motors. More commonly, liquid cooling systems are employed in high-performance electric motors. These systems circulate coolant through channels or jackets that are in direct contact with or surround the motor. In certain applications, liquid cooling is capable of dissipating more heat than air cooling to maintain the motor at acceptable temperatures, ensuring that the motor operates efficiently.

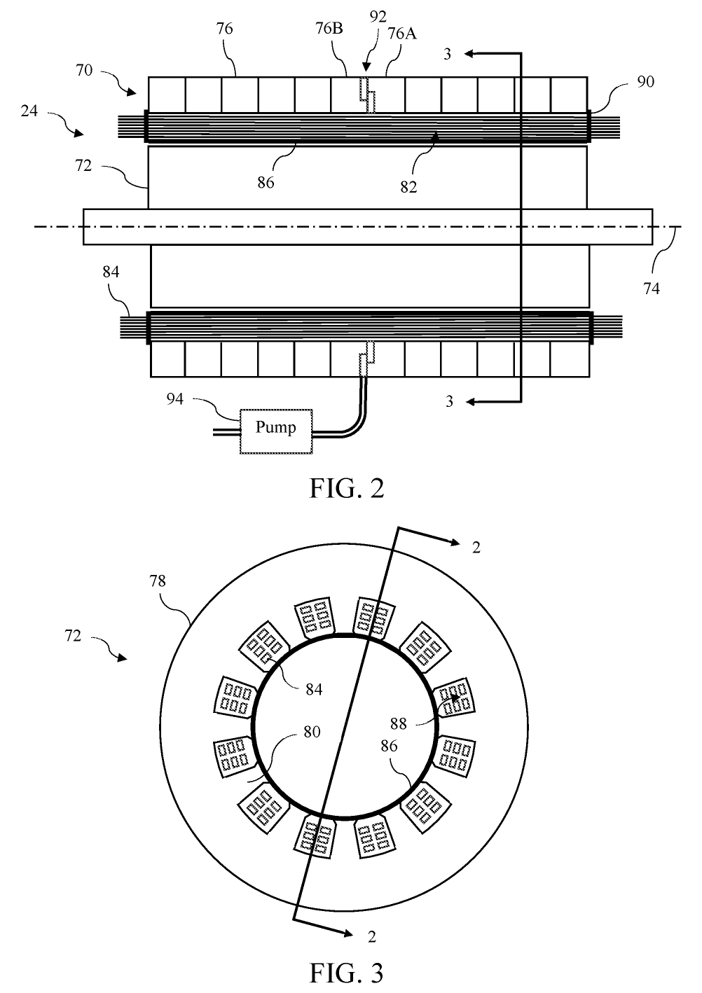

FIGS. 2 is cross-sectional view of a motor 24. Motor 24 includes a stator 70 and a rotor 72. The stator is fixed with respect to the vehicle 22, while the rotor is supported to rotate about axis 74. FIG. 3 is another cross-sectional view of stator 70. The stator includes a magnetically conductive rotor core formed from a stack of laminations 76. Each lamination has a cylindrical outer surface 78 and two flat end surfaces. When stacked, the outer surfaces of the laminations collectively form a cylindrical outer surface of the stator core and end surfaces of the outermost laminations form end surfaces of the stator core. The laminations also have an inner surface which includes a set of projections 80. Collectively, the projections of the stack of laminations for stator poles separated by axial slots 82. Electrically conductive windings 84 are placed within the slots. The windings include straight sections with the slots and end windings on both ends of the stator which connect the straight sections to form loops wound around the poles. The end windings are connected to three phase terminals. Voltages at the three phase terminals induce changing electrical currents in the windings which, in turn, induce changing magnetic fields in the stator poles. For clarity, only the straight section of the windings are illustrated in FIG. 2.

A plastic barrier 86 connects the tips of the adjacent poles, enclosing the slots 82 to form axial cooling channels 88. Plastic end caps 90 are connected to the barrier on each end of the stator core. As discussed later, these end caps include slots which position the straight sections of the windings with respect to the slots. During operation, heat is generated around the windings. Coolant flows past the windings to remove this heat. Two of the laminations, 76A and 76B, are specially defined to define a set of radial coolant channels 92 which extend from the outer surface of the core to each of the axial coolant channels 88. Pump 94 propels coolant into the radial cooling channels from which the coolant flows toward each end of the axial coolant channel and emerges through the end cap 90. After emerging from the end cap, the coolant cools the end windings and is then recirculated.

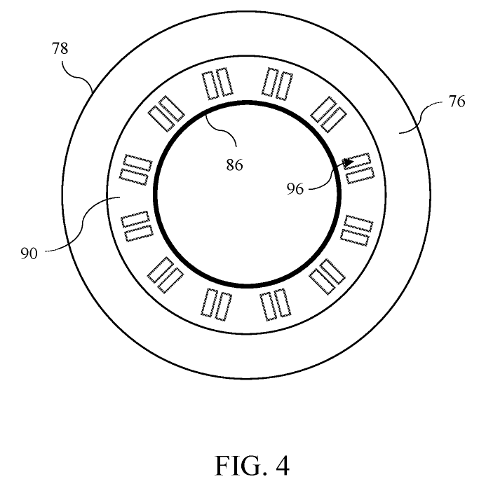

FIG. 4 is an end view of the stator core, after installation of the barrier 86 and end cap 90. The end caps define slots 96 which position the straight sections of winding with respect to the stator poles. The slot area exceeds the cross-sectional area of the windings such that there is an opening for coolant to flow out of the ends of the axial cooling channels and flow across the end windings.

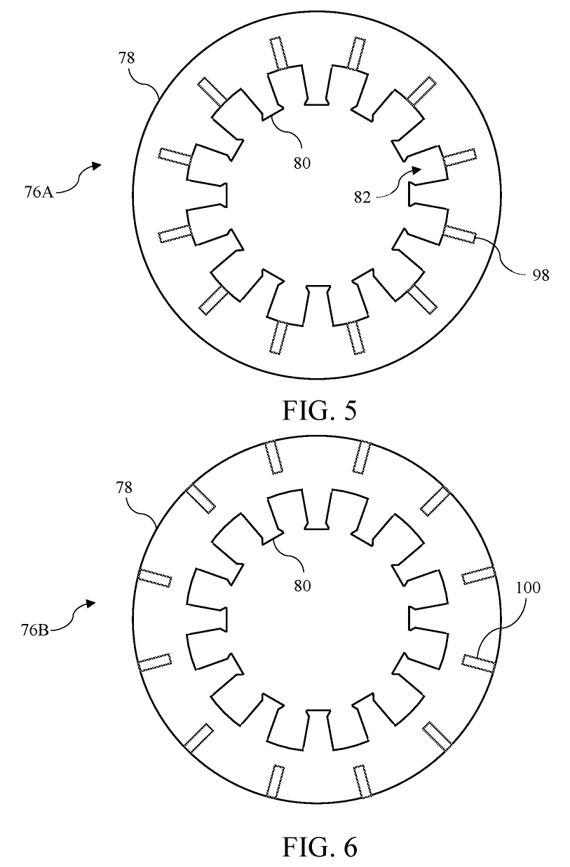

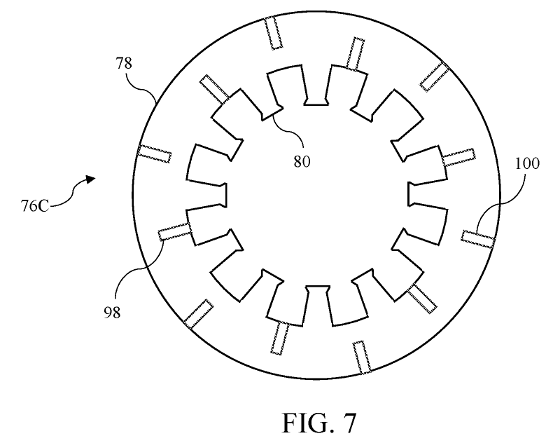

FIGS. 5 and 6 depict laminations 76A and 76B, respectively, which collectively form the radial coolant channels 92. As shown in FIG. 5, an end surface of lamination 76A includes a set of radial grooves 98 extending from the slots 82 partway to the outer surface 78. As shown in FIG. 6, an end surface of lamination 76B includes a set of radial grooves 100 extending inwardly from the outer surface 78. These lamination end surfaces are placed together in the stack such that the radial grooves of lamination 76A abut the radial grooves of lamination 76B to collectively define radial channels between the outer surface 78 and the slots 82. FIG. 7 illustrates an alternative embodiment in which a lamination 76C includes radial grooves 98 extending from the slots alternating with radial grooves 100 extending inwardly from the outer surface. Two such lamination are placed together with the grooves 98 of one lamination lined up with the grooves 100 of the other lamination. This reduces the number of unique parts that must be fabricated.

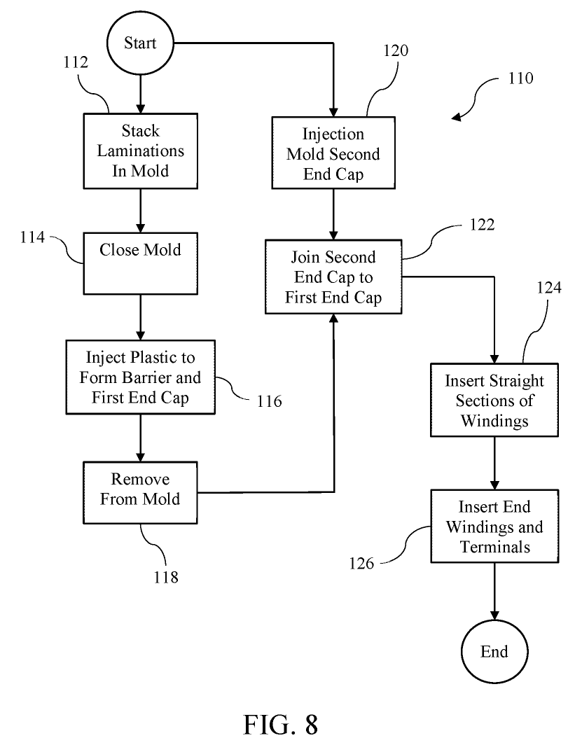

There are a number of ways that the barrier 86 and the end caps 90 may be fabricated and installed on the stator. FIG. 8 illustrates one possibility. In this process, the barrier 86 and one of the end caps 90 is over-molded onto the stack of laminations. It is also possible to fabricate the barrier separately and install it onto the stack of laminations. This over-molding process ensures that the barrier is secured to the laminations in a very repeatable fashion. At 112, the laminations are stacked within a mold. The bottom of the mold may include projections for volumes that will not be occupied by either the laminations of the plastic. This may include a central cylindrical projection which corresponds to the space that will eventually be occupied by the rotor and the air gap between the rotor and the stator. Additionally, there may be projections corresponding to the axial coolant channels and the straight sections of winding. The top of the mold may have projections corresponding to the slots 96 in one of the end caps. At 114, the mold is closed. At 116, plastic is injected into the mold, in a liquid state, and solidifies to form the barrier and one of the end caps. At 118, the stack of laminations, with the barrier and one end cap, is removed from the mold.

The other end cap may be separately injection molded at 120. At 122, the second end cap is attached and bonded to the barrier at the opposite end the stack of laminations from the first end cap. The end cap and barrier may have featured which ensure correct alignment. At 124, the straight sections of the windings are inserted. Slot liners may be eliminated because the slots guide the windings to the correct location with respect to the stator poles. At 126, the end windings and terminals are attached to the straight sections of the windings.

While exemplary embodiments are described above, it is not intended that these embodiments describe all possible forms of the present invention. Rather, the words used in the specification are words of description rather than limitation, and it is understood that various changes may be made without departing from the spirit and scope of the present invention. Additionally, the features of various implementing embodiments may be combined to form further embodiments of the present invention.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A stator for an electric motor, the stator comprising:
a magnetically conductive core having two end surfaces connected by an outer surface and an inner surface, the inner surface defining a plurality of axial stator poles separated by a plurality of axial slots, the core further defining a plurality of radial coolant channels between the outer surface and the slots;
electrically conductive windings within the slots; and
a barrier connecting tips of the stator poles to close off the slots thereby defining axial coolant channels around the windings and extending between the end surfaces.

2. The stator of claim 1, wherein the core comprises a stack of laminations, each lamination forming a segment of the outer surface, the stator poles, and the axial slots, the stack including:
a first lamination defining a plurality of first radial grooves each extending from the outer surface towards one of the axial slots; and
a second lamination defining a plurality of second radial grooves each extending from one of the slots toward the outer surface and abutting one of the first radial grooves to form one of the radial coolant channels.

3. The stator of claim 2 wherein the first radial grooves do not extend to the axial slot and the second radial grooves do not extend to the outer surface.

4. The stator of claim 1 further comprising two end caps connected to opposite ends of the barrier, the end caps defining slots to position the windings.

5. The stator of claim 4 wherein the barrier and the end caps are electrical and magnetic insulators.

6. The stator of claim 4 where in the barrier and the end caps are plastic.

7. The stator of claim 1 wherein a subset of the axial coolant channels is filled with varnish.

8. A stator core comprising a stack of laminations, each lamination having a cylindrical outer surface and flat end surfaces, each lamination having a plurality of inward facing projections, the laminations including:
a first lamination defining a plurality of first radial grooves in one of the flat end surfaces, each first radial groove extending inwardly from the outer surface; and
a second lamination defining a plurality of second radial grooves in one of the flat end surfaces, each second radial groove extending outwardly from between two of the projections and abutting one of the first radial grooves to form a radial channel.

9. The stator core of claim 8, wherein the first radial grooves do not extend to an inner surface and the second radial grooves do not extend to the outer surface.

10. The stator core of claim 9, further comprising a barrier connecting tips of the projections to define axial coolant channels.

11. The stator core of claim 10, further comprising two end caps connected to opposite ends of the barrier, the end caps defining slots to position windings.

12. A motor comprising:
a magnetically conductive stator core having two end surfaces connected by an outer surface and an inner surface, the inner surface defining a plurality of axial stator poles separated by a plurality of axial slots, the stator core further defining a plurality of radial coolant channels between the outer surface and the slots;
electrically conductive windings within the slots;
a barrier connecting tips of the stator poles to close off the slots thereby defining axial coolant channels around the windings and extending between the end surfaces; and
a pump configured to propel a coolant through the radial cooling channels into the axial coolant channels.

13. The motor of claim 12, further comprising a rotor supported for rotation within the stator core.

14. The motor of claim 12, wherein the core comprises a stack of laminations, each lamination forming a segment of the outer surface, the stator poles, and the axial slots, the stack including:
a first lamination defining a plurality of first radial grooves each extending from the outer surface towards one of the axial slots; and
a second lamination defining a plurality of second radial grooves each extending from one of the slots toward the outer surface and abutting one of the first radial grooves to form one of the radial coolant channels.

15. The motor of claim 14, wherein the first radial grooves do not extend to the axial slot and the second radial grooves do not extend to the outer surface.

16. The motor of claim 12, further comprising two end caps connected to opposite ends of the barrier, the end caps defining slots to position the windings.

17. The motor of claim 16, wherein the barrier and the end caps are electrical and magnetic insulators.

18. The motor of claim 16, where in the barrier and the end caps are plastic.

19. The motor of claim 12, wherein a subset of the axial coolant channels are filled with varnish.
